(19) United States
(12) Patent Application Publication
(10) Pub. No.: US 2006/0177660 A1
(43) Pub. Date: Aug. 10, 2006

(54) Core-shell nanostructures and microstructures

(76) Inventors: Challa Kumar, Baton Rouge, LA (US); Elizabeth J. Podlaha, Baton Rouge, LA (US); Zhanhu Guo, Baton Rouge, LA (US); Josef Hormes, Baton Rouge, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 11/054,513

(22) Filed: Feb. 9, 2005

(51) Int. Cl. B32B 5/16

(52) U.S. Cl. 428/403; 977/762; 977/777; 977/810; 428/570; 427/443.1

(57) ABSTRACT

A method is disclosed for synthesizing core-shell nanoparticles or microparticles in an aqueous solution. A displacement reaction produces a protective, noble metal shell around nanoparticles or microparticles, for example a copper shell around cobalt nanoparticles. In an electroless displacement reaction in an aqueous solution, a less noble metal core is oxidized by cations of a more noble metal in solution, and the noble metal ions are reduced by the less noble atoms of the metal core, forming a thin layer of the reduced noble metal on the surface of the core metal. The formation of the nanoscale shell is self-terminating once the core is fully covered, because the core metal is then inaccessible for further redox reaction with ions in solution. The magnetic core is preferably a ferromagnetic metal, e.g., Co, Fe, Ni. The shell is a more noble metal, e.g., Cu, Ag, Au, Pt, or Pd.

The development of this invention was partially funded by the Government under contract number ECS-9984775 awarded by the National Science Foundation, and under a subcontract under prime contract number NSF/LEQSF (2001-04) RII-03 awarded by the National Science Foundation, and under contract number MDA972-03-C-0100 awarded by the Defense Advanced Research Projects Agency. The Government has certain rights in this invention.

This invention pertains to nanostructures and microstructures, particularly to nanostructures and microstructures having a core-shell structure, where the core comprises one metal and the shell comprises a different metal.

Iron-group nanoparticles, i.e., nanoparticles of cobalt, iron, and nickel, have unusual and useful magnetic properties. For example, their coercivity is enhanced as compared to thin films or microscale particles, making them useful in high-density data storage, due to their inherent high magnetic anisotropy.

Nanoparticles of iron-group element alloys have also been synthesized, including for example PtCo, PtFe, FeCo, CoNi, and CoNiB.

A common difficulty in making these nanoparticles has been the control of surface properties. Iron-group nanoparticles readily oxidize in air. Preparation and storage in a protective atmosphere, such as nitrogen gas, is one approach to this problem, but it limits potential uses for the nanoparticles.

Another technique that has been used to control the surface chemistry of nanoparticles has been to fabricate a shell of a relatively unreactive metal around the nanoparticle core, for example a shell of gold, platinum, or silver. The methods that have been used for forming these shells have included reducing metallic ions from a microemulsion with a reducing agent; displacement reactions in an organic solvent, where part of a cobalt nanoparticle is directly sacrificed as the reducing agent for the deposition of gold or platinum; and high-temperature (˜200° C.) transmetalation to form a gold shell around iron nanoparticles. To the knowledge of the inventors, all prior examples of such reactions have taken place in organic solvents. To the knowledge of the inventors, it has not previously been reported that such reactions might successfully be carried out-in aqueous solution. Previous methods of making core-shell nanoparticles have primarily used organic solvents or in some cases vapor-phase routes. Some of these prior methods may produce gaps in the shell coatings that facilitate unwanted oxidation of the core metal. Placing a shell or matrix around a ferromagnetic core can enhance overall magnetic coercivity and raise the blocking temperature, due to exchange coupling under an applied magnetic field.

The blocking temperature is the highest temperature at which a substance exhibits ferromagnetic behavior. Thus, in many applications, it is desirable to have a high blocking temperature, as a higher blocking temperature means a wider range of temperatures over which ferromagnetic properties are exhibited. In particular, if the blocking temperature is below room temperature, then a device or system relying on ferromagnetism will need to be cooled in order to work; further, in vivo applications in humans and other warm-blooded animals require blocking temperatures that are at least as high as body temperature. Ferromagnetic nanoparticles formed of a single metal typically have blocking temperatures that are so low that their practical utility is limited. It is known that placing a shell around a ferromagnetic core can increase the blocking temperature. Thus there is a need for improved methods of forming such core-shell nanoparticles and microparticles.

P. Paulus et al., “Magnetic properties of nanosized transition metal colloids: the influence of noble metal coating,” Eur. Phys. J. D: Atom., Mol. Opt. Phys., vol. 9, pp. 501-504 (1999) discloses a study of Fe and Co colloidal particles stabilized by organic ligands. Magnetic properties (magnetic anisotropy, blocking temperature, saturation magnetization) were compared for pure and gold-coated particles. The gold coatings were prepared by dispersing the colloidal metal particles in toluene, and reaction with AuCl₃.

H. Bönnemann et al., “A size-selective synthesis of air stable colloidal magnetic cobalt nanoparticles,” Inorg. Chim. Acta., vol. 350, pp. 617-624 (2003) discloses a size-selective preparation route to air-stable, monodisperse, colloidal cobalt nanoparticles by thermolysis of Co₂(CO)₈ in the presence of aluminum alkyls. The chemical nature of the surfactant was reported to have a significant influence on the stability, electronic structure, and geometric structure of the cobalt nanoparticles.

E. Carpenter et al., “Magnetic properties of iron and iron platinum alloys synthesized via microemulsion techniques,” J. Appl. Phys., vol. 87, pp. 5615-5617 (2000) discloses the chemical synthesis and magnetic characterization of metallic iron nanoparticles and iron/platinum alloy nanoparticles. Gold coatings were reported to inhibit oxidation. The nanoparticles, and the gold coatings, were formed in reverse micelles of cetyltrimethylammonium bromide, using 1-butanol as a co-surfactant, and octane as the oil phase. The metal ions were reduced with NaBH₄.

J. Guevara et al., “Large variations in the magnetization of Co clusters induced by noble-metal coating,” Phys. Rev. Lett., vol. 81, pp. 5306-5309 (1998) reports theoretical, ab initio calculations predicting electronic and magnetic properties of small Co clusters coated with Ag or Cu.

J. Park et al., “Synthesis of ‘solid solution’ and ‘core-shell’ type cobalt-platinum magnetic nanoparticles via transmetalation reactions,” J. Am. Chem. Soc., vol. 123, pp. 5743-5746 (2001) discloses the synthesis of Co—Pt nanoparticles, in both “solid solution” and “core-shell” form. The core-shell particles were synthesized by reacting Co nanoparticles with Pt(hexafluoroacetylacetonate)₂ in a nonane solution with dodecane isocyanide as a stabilizer.

B. Ravel et al., “Oxidation of iron in iron/gold core/shell nanoparticles,” J. Appl. Phys., vol. 91, pp. 8195-8197 (2002) discloses the preparation of iron/gold and gold/iron/gold core-shell nanoparticles by reduction of metal ions in a reverse micelle formed using the surfactant system of cetyltrimethylammonium bromide, octane, and n-butanol. Using X-ray absorption spectroscopy, the authors concluded that the iron component of the nanoparticles was extensively oxidized, and suggested that undesired oxidation of iron was a persistent problem in the core/shell nanoparticles.

J. Rivas et al., “Structural and magnetic characterization of Co particles coated with Ag,” J. Appl. Phys., vol. 76, pp. 6564-6566 (1994) discloses the preparation of Co nanoparticles coated with Ag. Co nanoparticles (˜30 nm) were dispersed with sodium dodecylsulfate in aqueous solution containing AgNO₃ and EDTA. Silver ions were then absorbed on the particles, which acted as nucleation centers. The solution was later irradiated with ultraviolet light for 30 minutes to reduce the silver ions and obtain a metallic silver layer coating the cobalt.

S. Son et al., “Designed synthesis of atom-economical Pd/Ni bimetallic nanoparticle-based catalysts for Sonogashira coupling reactions,” J. Am. Chem. Soc., vol. 126, pp. 5026-5027 (2004) discloses the synthesis of Ni/Pd core/shell nanoparticles by thermal decomposition of Pd and Ni metal-surfactant complexes. A mixture of Pd(acac)₂ and Ni(acac)₂ in trioctylphosphine was injected into oleylamine, and allowed to react for 30 minutes at various temperatures between 205° C. and 235° C.

We have discovered a method for synthesizing core-shell nanoparticles or microparticles in aqueous solution, without the need for an organic solvent. The novel method may be implemented inexpensively, and is not technically difficult to conduct. The novel method may be used not only for nanoparticles, but also for micron-scale particles. The novel method may be used for particles having at least one dimension that is between about 1 nm and about 100 μm, preferably between about 1 nm and about 100 nm. By carrying out the reaction in aqueous solution, the expense and environmental problems of organic solvents may be avoided. In addition, it is easier to control pH in aqueous solution. An acidic pH promotes the removal of any oxide impurities from the surface of the core. The presence of oxides in the core, even in trace amounts, can both inhibit the formation of a noble metal shell around the core, and can also promote oxidation and destruction of the core over a period of time.

A displacement reaction produces a protective, noble metal shell around nanoparticles (or microparticles), for example a copper shell around cobalt nanoparticles.

In an electroless displacement reaction in an aqueous solution, a less noble metal-core is oxidized by cations of a more noble metal in solution, and the noble metal ions are reduced by the less noble atoms of the metal core, forming a thin layer of the reduced noble metal on the surface of the core metal:
Core: less noble metal, M₁→M₁⁺ⁿ+ne⁻ (oxidation, anodic process)
Shell: more noble metal, M₂^{+m}+me⁻→M₂ (reduction, cathodic process)
Unlike most prior synthetic methods, the formation of the nanoparticle shell is self-terminating once the core is fully covered, because the core metal is then inaccessible for further redox reaction with ions in solution.

The pH of the solution should be selected to disfavor formation of metal oxides and hydroxides. Taking Co at room temperature as an example, the Pourbaix diagram shows that CoO will tend to form at pH above about 6. However, the pH should not be too acidic, or a hydrogen evolution side reaction will compete with the Cu displacement reaction, resulting in dissolution of the Co nanoparticles. The preferred pH in this case is thus around pH 4, to favor dissolution of any metal oxide impurities from the surface of the core, and to inhibit the formation of any metal hydroxide impurities, but without a competing hydrogen evolution reaction at a rate sufficient to consume a substantial portion of the core. See E. Podlaha, “Selective electrodeposition of nanoparticles into metal matrices,” Nano Letters, vol. 1, pp. 413-416 (2001).

The core nanoparticles are preferably mixed with a surfactant such as dodecyldimethyl propane ammonium sulfonate (sulfobetaine, SB-12), to promote dispersal of the nanoparticles in the aqueous electrolyte. The noble metal ions are preferably complexed in solution by a ligand, such as citrate.

The magnetic core is preferably a ferromagnetic metal, e.g., Co, Fe, Ni. The shell is a more noble metal, e.g., Cu, Ag, Au, Pt, or Pd. In the displacement reaction, the less active metal ions are reduced by the more active atoms of the metal substrate, following the order of metal nobility. There is no need for a separate reducing agent. The more active metal of the substrate core reduces the noble metal ions in solution.

For example, following are standard electrode potentials of several metals that may be used in practicing this invention (in an aqueous solution at 25° C., versus NHE:

| Core Metal | Shell Metal |
|---|---|
| Co/Co²⁺ −0.28 V | Cu/Cu²⁺ 0.34 V |
| Fe/Fe²⁺ −0.44 V | Ag/Ag⁺ 0.80 V |
| Ni/Ni²⁺ −0.26 V | Au/Au³⁺ 1.50 V |
| | Pt/Pt²⁺ 1.19 V |
| | Pd/Pd²⁺ 0.95 V |

It is also possible to prepare a core-shell nanoparticle in which both the core and the shell are ferromagnetic, provided that the shell metal is more noble than the core. For example, a Ni shell may be formed on a Co or Fe core; or a Co shell may be formed on a Fe core.

Surprisingly, the novel core-shell synthesis may not only be conducted in an aqueous solution, it may even be conducted in the presence of ambient oxygen from air. It is not, in general, necessary to conduct the reaction under an inert atmosphere.

As one example, we have successfully generated copper shells on cobalt nanoparticles and microparticles in aqueous solutions at room temperature. To the inventors' knowledge, no one has previously reported the successful generation of a copper shell—iron group core nanoparticle or microparticle. To the knowledge of the inventors, no one has previously prepared a copper shell/cobalt core nanoparticle or microparticle.

In one preferred embodiment, the exchange reaction with cobalt nanoparticles or microparticles occurs in an acidic copper-citrate electrolyte, an environment in which cobalt oxides are not stable. Without wishing to be bound by this theory, it is believed that citrate (sodium citrate in our experiments) slows the deposition of copper (or other noble metal) by complexing with it, thus slowing the deposition of copper and making the copper layer more uniform. Citrate serves several roles in aqueous solution. It acts as a ligand for both Cu and Co, it slows the displacement reaction via an adsorbed intermediate, and it buffers the electrode (Co/Cu) surface. Although a complexing agent such as citrate is preferred, its presence may not be crucial to the functioning of the invention. Other retarding agents may also be used, agents that bind to or coordinate with the cations in solution, or to the atoms on the surface of the particles, to slow the rate of deposition and to make the deposited layer more uniform. Such alternative retarding agents might include, for example, EDTA or boric acid. However, the pH at the deposition site is important. The citrate (or other complexing agent) may influence the pH. Cu can also, for example, be deposited onto a Co surface with an acid electrolyte without sodium citrate. However, in a typical CuSO₄/H₂SO₄ electrodeposition bath the pH is below 1. At such a low pH, the competing H⁺ reduction (evolution of hydrogen gas) would compete with the Cu reduction, resulting in the dissolution of the Co core. Raising the pH to a more acceptable range requires a ligand, such as citrate, to keep the copper ions in solution without precipitation. Other ligands may be used that will complex with the core and shell metal ions, and maintain them in solution at an acceptable pH. In the case of Co and Cu, the pH should preferably be close to 4, and should not exceed 6. Examples of other possible complexing agents include bidentate ligands such as ethylenediamine, acetylacetonate, phenanthroline, ethylenediaminetetraacetic acid (EDTA), 1,2-ethanediylbis(diphenylphosphine) (dppe), tartrate, and oxalate. To the knowledge of the inventors, no prior work has been reported concerning the use of citrate (or other complexing agent as just described) in the deposition of a shell onto a nanoparticle.

Low pH plating baths for all of the metals Co, Cu, Ag, Ni, Au, Pt, and Pd are known in the art. Low pH gold plating baths are perhaps less common than those for the other metals. But acidic gold plating baths are also known in the art and include, for example, the following acidic gold baths from Palloys Pty. Ltd. (Darlingshurst, NWS, Australia, palloys.com.au): Wilaplat™ gold baths 750S, 750SC, 750 Si, 750Sci, and AC3. For use in the present invention, each of these gold baths may be used at a pH about 4. If operated at a lower pH (e.g., the manufacturer's recommended pH of 1.5 to 1.8 for some of these gold baths), then the gold ion concentration would need to be increased suitably so that the gold displacement reaction competes effectively against hydrogen gas evolution. Some of these baths include cyanide, and accordingly should be handled with appropriate precautions.

A slower deposition rate, resulting from a complexed noble metal-ligand (e.g., Cu-citrate) species, may favor uniformity of the coverage on the surface of the core particle (e.g., Co), although we do not yet have experimental evidence to support this hypothesis. In our examples, we observed a uniform coating of Cu onto Co core particles having a mean diameter of about 3.2 nm when the deposition rate was about 2.5×10⁻²¹ mole/s/particle. We estimated the thickness of the copper layer to be about 0.8 nm, about 3 atoms thick.

Experimental data have confirmed that oxides were essentially absent from the resulting prototype Co—Cu core-shell nanoparticles. Thermodynamically, Cu and Co should have limited miscibility with one another, supporting the stability of the Cu shell. There is also the possibility that some nonequilibrium phases of Co—Cu mixtures might be present, however.

To the knowledge of the inventors, no one has previously prepared core/shell nanoparticles or microparticles in aqueous solution. (The aqueous phase in the reverse micelles that have been used in some prior techniques is not considered to be a true “aqueous solution” in this context.)

Core-shell nanoparticles in accordance with the present invention have a variety of uses, including, for example, uses as catalysts, biosensors, drug delivery systems, magnetic sensing, magnetic data storage, and giant magnetoresistance sensors. A few examples are described below.

Co—Cu core-shell nanoparticles particles may be used for magnetic data storage at temperatures below the blocking temperature (235K, −38° C.), which is substantially above the temperature of liquid nitrogen. Increasing the shell thickness and particle size would be expected to increase the blocking temperature. Core-shell nanoparticles in accordance with the present invention may be used in cryogenic environments to store data, or as elements of microdevices for purposes such as monitoring biomedical and biochemical processes. Core-shell microparticles or nanoparticles may be used at room temperature in bio-detectors with giant magnetoresistant (GMR) sensors with improved sensitivity; if the blocking temperature is below ambient temperature, the devices may need to be cooled. The nanoparticles may be used to monitor transport phenomena in microchannels of microdevices or nanodevices.

The uses of palladium and platinum as catalysts are too numerous to require citation. Palladium and platinum are rather expensive metals. The active portion of a solid catalyst is generally limited to the surface of the catalyst. It is, well established that the activity of a solid catalyst normally increases with increased surface area, leading to the use of microparticles and even nanoparticles of platinum and palladium as catalysts in many types of reactions. Even in a nanoparticle, the active portion the catalyst is generally limited to the surface. When the catalyst is a relatively expensive metal such as platinum or palladium, even in a nanoparticle a large portion of the expensive metal, the portion found in the core of the particle, is effectively sequestered from catalysis, and in that sense is “wasted.” By using a less expensive metal for the catalytically inaccessible core, for example nickel; with the more expensive, catalytically active metal limited to a surface layer only a few atoms thick, for example platinum, the cost of the catalyst is reduced.

Nevertheless, the composition of the core can have an effect on catalytic properties, for reasons that are not entirely clear. For example, it has been reported that Ni core, Pd shell nanoparticles were superior to pure Pd nanoparticles of comparable size in catalyzing the Sonogashira coupling reaction, and in catalyzing the oxidation of CO. See, e.g., S. Son et al., J. Am. Chem. Soc., vol. 126, pp. 5026-5027 (2004).

“Biofunctionalization” is the attachment of biological molecules such as DNA, enzymes, or other proteins to noble metal surfaces or nanoparticles. For example, a thiol group will coordinate with a gold surface, and a linker can bind the thiol group to a biological molecule. Biofunctionalization of nanoparticles has been used for several purposes, including cell separation, drug delivery and diagnosis. As just one example, see C. Mirkin et al., Nature, vol. 405, pp. 626-627 (2000). Likewise, magnetic nanoparticles have been used for medical diagnosis and therapy. See, e.g., S. Mornet et al., “Magnetic nanoparticle design for medical diagnosis and therapy,” J. Mater. Chem., vol. 14, pp. 2161-2175 (2004); Z. Lu et al., “Magnetic Switch of Permeability for Polyelectrolyte Microcapsules Embedded with Co@Au Nanoparticles,” Langmuir ASAP Article (Jan. 26, 2005).

Nanoparticles having both a magnetic core and a noble metal shell provide the functionalities of both a magnetic core and a surface layer to which biomolecules may readily be attached. These unique features new opportunities in the biomedical field. See, e.g., J. West et al., “Engineered nanomaterials for biophotonics applications: improving sensing, imaging, and therapeutics,” Ann. Rev. Biomed. Eng., vol. 5, pp. 285-297 (2003); and J. Nam et al., “Bio-Bar-Code-Based DNA Detection with PCR-like Sensitivity,” J. Am. Chem. Soc., vol. 126, pp. 5932-5933 (2004).

The protective shell makes it possible to use nanoparticles or microparticles in harsh environments that would otherwise be unsuited for particles formed of the core metal. The shell may be used to render particles biocompatible, and may be used to facilitate chemical functionalization of the particles. In many instances the primary use of the shell is to protect the inner core (for example, from oxidation). However, in some circumstances it may be desirable to derivativize the shell, for example for detection of biological agents or for drug delivery. For example, thiol groups readily coordinate with gold surfaces. By linking a thiol group to a biological molecule, the biological molecule may be tethered to a gold shell—cobalt core nanoparticle. A magnetic field may then be used to concentrate or “focus” the functionalized nanoparticles in a region of interest, for example, a tissue to be treated.

The process may be implemented with a variety of sizes and shapes of materials, including for example spheres, disks, wires, prisms, tubes, rods, and cubes. The process may be implemented both at the nanometer scale (“nanoparticles”), and at the micrometer scale (“microparticles”). The core portion of the core-shell particles may be prepared by physical or chemical means, including means that are known in the art for synthesizing nanoparticles and microparticles.

### BRIEF DESCRIPTION OF THE DRAWINGS

FIG. 1 depicts Co K-edge XANES spectra for several specimens.

FIGS. 2(a) and (b) depicts the temperature dependence of magnetization of Co nanoparticles and Co—Cu nanoparticles.

FIGS. 3(a) and (b) depict the field dependence of magnetization for Co nanoparticles and Co—Cu core-shell nanoparticles, respectively.

FIG. 4 depicts an Evans diagram for individual Co/Co²⁺ and Cu/Cu²⁺ reactions.

FIG. 5 depicts a typical UV/Vis absorption spectrum for synthesized Co—Cu core-shell nanoparticles dispersed in deionized water.

FIG. 6 depicts XRD spectra for pure nano and micron cobalt particles, for nano and micron-sized core-shell Co—Cu particles, and for oxidized Co and Co—Cu nanoparticles.

FIG. 7(a) depicts magnetization measurements for Co nanoparticles, freshly-prepared Co—Cu core-shell nanoparticles, and Co—Cu core-shell nanoparticles aged 12 weeks. FIG. 7(b) depicts temperature-dependent magnetization measurements for Co microparticles, and freshly-prepared Co—Cu core-shell microparticles.

FIGS. 8(a) and (b) depict the electrical resistance of Co—Au and Co—Cu nanoparticles, respectively, as functions of temperature.

### EXAMPLE 1

### Synthesis of Cobalt Nanoparticles

We used a wet chemical approach to synthesize the cobalt nanoparticles in tetrahydrofuran (THF), using a sulfobetaine (SB-12, 98%) as a surfactant. The surfactant electrostatically stabilizes the Co nanoparticles, thereby inhibiting agglomeration of nanoparticles. (SB-12 is hydrophillic due to the sulfobetaine group on the end of the molecule. SB-12 may be used to stabilize Co nanoparticles in different solvents, including both THF and water.) Other suitable surfactants with hydrophile-lipophile balance (HLB) values greater than about 10 might also be used in lieu of SB-12, for example SB-8, SB-10, SB-14, SB-16, SB-18, poly-ethylene glycol, dioctyl sodium sulfosuccinate, or polyoxyethylene monolauryl ether.

Cobalt chloride (anhydrous, 99%), cobalt particles (<2 micrometer, 97%), tetrahydrofuran (THF, 99.90% pure, packaged under nitrogen), lithium hydrotriethyl borate (superhydride) as 1 M solution in THF, SB-12, and ethanol (reagent anhydrous, water<0.003%) were purchased from Aldrich Chemical Company. Cupric sulfate and sodium citrate were purchased from Fisher Scientific. All the reagents were used as received, without further treatment.

A mixture of 100 ml SB-12 (0.015 M) in THF and 15 ml of a superhydride-THF solution (1 M lithium hydrotriethyl borate in THF) was added dropwise over 30 minutes to a solution containing 100 ml CoCl₂ (0.0285 M) in THF under nitrogen gas with ultrasonication. The ultrasonication was continued for an additional hour, and the reaction was then quenched by adding ethanol. The solution was left undisturbed overnight, and cobalt nanoparticles precipitated. The cobalt nanoparticles were then washed thoroughly with THF and dried under vacuum. We confirmed by DSC-TGA analysis (TA Instruments, SDT 2960) that surfactant remained on the surface of the nanoparticles, even after repeated washings with ethanol.

### EXAMPLE 2

### Formation of Copper Shell on Cobalt Nanoparticles through Displacement Reaction

The cobalt nanoparticles from Example 1 were added to a copper-citrate electrolyte, containing 0.25 M CuSO₄.5H₂O, and 0.3 M sodium citrate C₆H₅Na₃O₇.2H₂O, at a pH of 4.0. The reactants were agitated ultrasonically for 1 hour. Agitation by ultrasound is preferred, because it helps to promote mass and heat transfer, and is believed to help in cleaning the surfaces of the nanoparticles, to aid in the formation of a uniform, nonporous shell. But other means of agitation should work also, such as mechanical stirring. After the reaction the copper-coated cobalt particles were allowed to settle, and were washed thoroughly with deionized water. The particles were then filtered and dried under nitrogen flow.

The pH in this reaction should be sufficiently acidic so that Co is in equilibrium with CO⁺²_{aq}—rather than with CoO—in order that oxidized Co from the surface of the core goes into solution rather than form an oxide coating. Likewise, it is preferred not to:expose the Co nanoparticles to air before they have been coated with noble metal, to inhibit formation of CoO. Therefore, it is preferred to work under an inert atmosphere such as nitrogen. The resulting nanoparticles were characterized by transmission electron microscopy, magnetization measurements, and X-ray absorption spectroscopy. (This reaction could be carried out in air, because the oxide of the core metal, e.g. CoO, is unstable at the acidic pH employed. It is nevertheless preferred to conduct the reaction under an inert atmosphere, such as nitrogen or argon, to reduce the loss of core metal to oxidation.)

### EXAMPLE 3

### Characterization of Co—Cu Core-Shell Nanoparticles by TEM

The nanoparticles from Example 2 were characterized by transmission electron microscopy (TEM) (JEOL 2010). Samples for TEM were prepared by dropping and evaporating an ethanol suspension of Co particles, or an aqueous suspension of Co—Cu core-shell particles onto a carbon-coated copper grid or a gold grid, respectively.

TEM images of the Co—Cu nanoparticles (not shown) revealed discretely dispersed particles, having a diameter of 3.2±0.6 nm (mean±S.D.). Fringes were observed on the surfaces of the particles, with a thickness corresponding to an interplanar distance of 0.18 nm. The lattice parameters for Cu and Co are 0.3615 nm and 0.3544 nm, respectively. Assuming a cubic structure, the observed d-spacing corresponds to a (2 0 0) fcc plane, consistent with a Cu shell. However, due to the small difference between the Co and Cu lattice constants, the measured d-spacing cannot be said to be inconsistent with Co. A contrast difference arising from different orientations of lattice fragments with respect to the electron beam can sometimes be used as a distinguishing criterion for a core-shell structure. However, the very small difference between the atomic numbers, Z, for Co and Cu makes it difficult to distinguish a core-shell structure by TEM alone. The Cu shell thickness was estimated as 0.82 nm based on an average Cu content in the nanoparticles of 87.5 wt. %, as determined by atomic adsorption, assuming spherical particles and bulk densities. (Note that the core in this case was so small that the shell actually had a greater volume than the core.) The corresponding estimated loss in the Co radius is 0.78 nm.

### EXAMPLE 4

### Characterization of Co—Cu Core-Shell Nanoparticles by XAS and XANES

X-ray absorption spectroscopy (XAS) experiments were performed at the XMP double crystal monochromator beamline positioned at port 5A of the Center for Advanced Microstructures and Devices (CAMD) synchrotron radiation source of Louisiana State University. The storage ring was operated at an electron energy of 1.3 GeV. Experiments were performed in standard transmission mode using ionization chambers filled with inert gas at 1 atm pressure. A Lemmonier-type monochromator was equipped with Si (311) crystals, and the photon energy was calibrated relative to the absorption spectrum of a standard 7.5 μM Co foil, setting the first inflection point at an energy of 7709 eV. X-ray absorption near edge structure (XANES) spectra were collected in the −100 to +250 eV range relative to the Co K-edge, with approximate step sizes of 0.5 eV and 1 sec. integration times. Samples for XAS measurement were prepared by spreading a thin layer of the dried particles uniformly over Kapton® tape, in air for Co—Cu nanoparticles and in a glove box for Co nanoparticles.

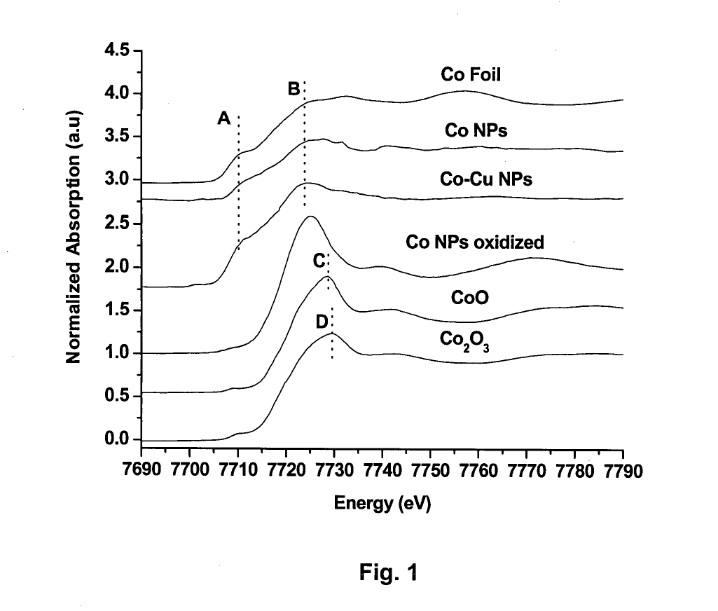

XAS indirectly verified the presence of a Co core. FIG. 1 depicts XANES Co K-edge spectra for several specimens: a standard hcp Co foil, Co nanoparticles prepared in a glove-box under nitrogen, Co—Cu nanoparticles exposed to air, Co nanoparticles exposed to air, and two cobalt oxide standards. The XANES spectrum of Co in the Co—Cu core-shell nanoparticles was more similar to that for the air-protected Co nanoparticles and the standard Co foil. The Co XANES spectrum for the Co—Cu sample exhibited a pre-edge feature at approximately 7709 eV (line A), attributed to an electron transition from a 1 s orbital to a hybridized p-d orbital, and a white line at about 7724 eV (line B). The position of the absorption edge in the Co—Cu spectrum, as well as its intensity, and the location of the maximum white line closely resembled those for the Co nanoparticles and the standard hcp Co foil. The chemical shift of the absorption edge to higher energies (7728 eV), lower pre-edge intensity and a higher white line (lines C and D) that were evident in the spectra of CoO and Co₂O₃ were not observed in the Co—Cu sample, nor in the N₂-protected Co nanoparticle sample. Co nanoparticles will readily oxidize when exposed to air. The XANES data demonstrated that the Cu shell effectively protected the Co nanoparticle core from oxidation.

### EXAMPLE 5

### Characterization of Magnetic Properties of Co—Cu Core-Shell Nanoparticles

Magnetic studies were carried out with a Quantum Design MPMS-5S Superconducting Quantum Interference Device (SQUID) magnetometer. The magnetization temperature dependence was measured in an applied magnetic field of 100 G between 4 K and 300 K using zero-field-cooled (ZFC) and field cooling (FC) procedures. The field dependence of magnetization was measured at 10 K and 300 K. The Co—Cu core-shell nanoparticle samples and Co nanoparticle samples were placed in gelatin capsules in powder form, under atmospheric conditions and in a glove box, respectively, before being inserted into the magnetometer.

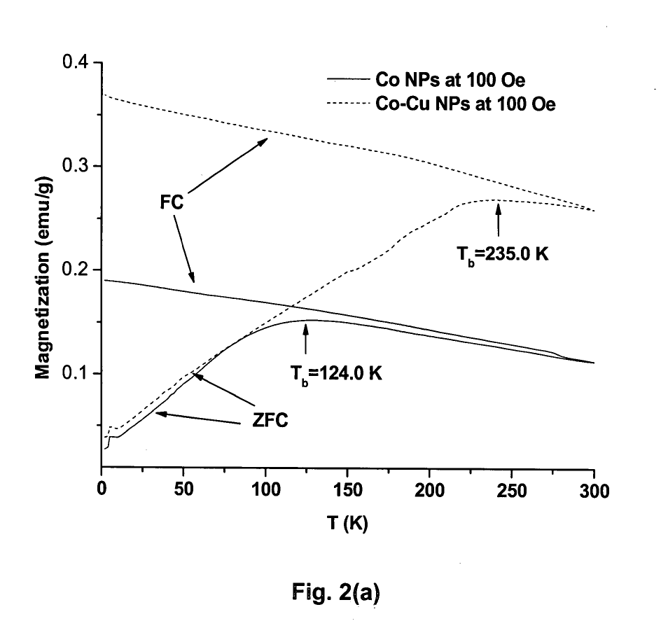

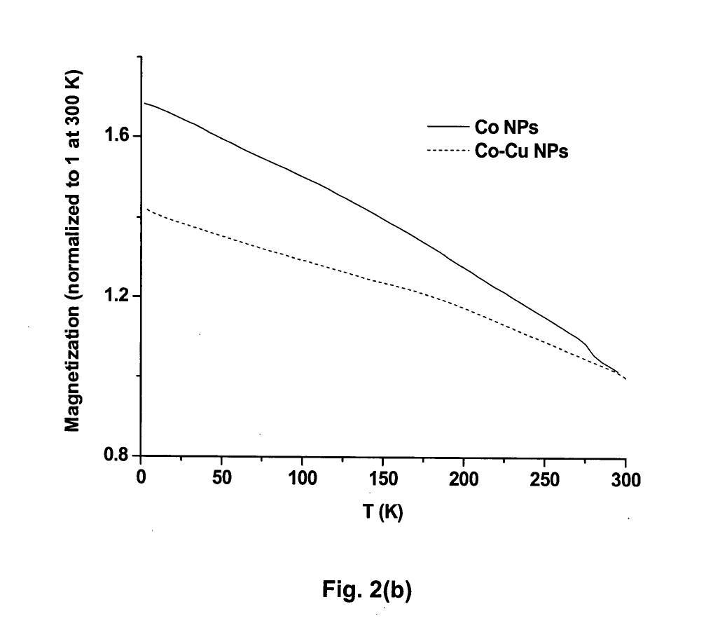

The temperature dependence of magnetization is depicted in FIGS. 2(a) and (b). The blocking temperature (T_{B}), the transition temperature between the ferromagnetic and the superparamagnetic state, was determined from the maximum in ZFC measurements. The T_{B} for the Co—Cu core-shell nanoparticles (235 K) was substantially higher than that for the precursor Co nanoparticles (124 K). An increase in blocking temperature due to antiferromagnetic exchange coupling has previously been reported for compacted Co—CoO core-shell nanoparticles particles, and for Co nanoparticles dispersed in a CoO matrix. Our data suggested that little or no CoO had formed, so the higher blocking temperature may have been due to an increase in dipole interactions between Co particles. In the field-cooled (FC) curve, magnetization decayed uniformly for both types of nanoparticles as the temperature increased, as a function of interactions among particles. The slope of the normalized FC magnetization curves in FIG. 2(b) was higher for the Co nanoparticles than that for the Co—Cu core-shell nanoparticles. The smaller slope for the FC magnetization of the Co—Cu core-shell nanoparticles suggests stronger inter-particle interaction as compared to Co nanoparticles, consistent with the observed increase in blocking temperature.

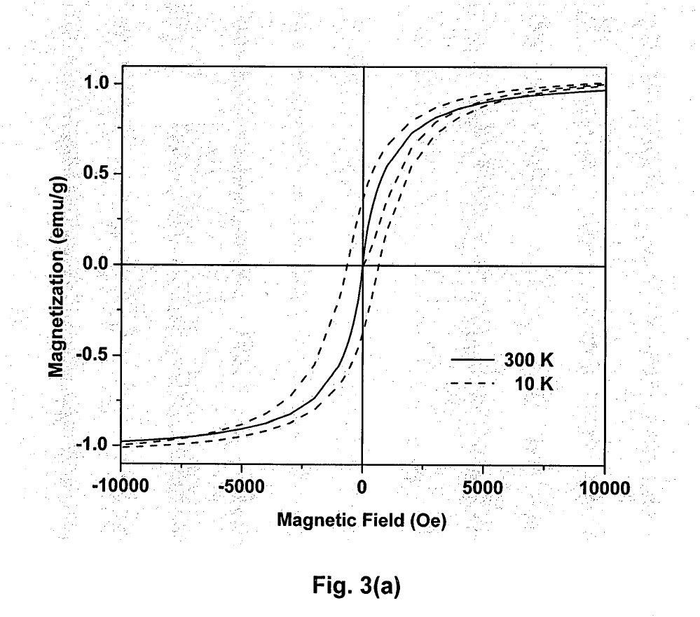

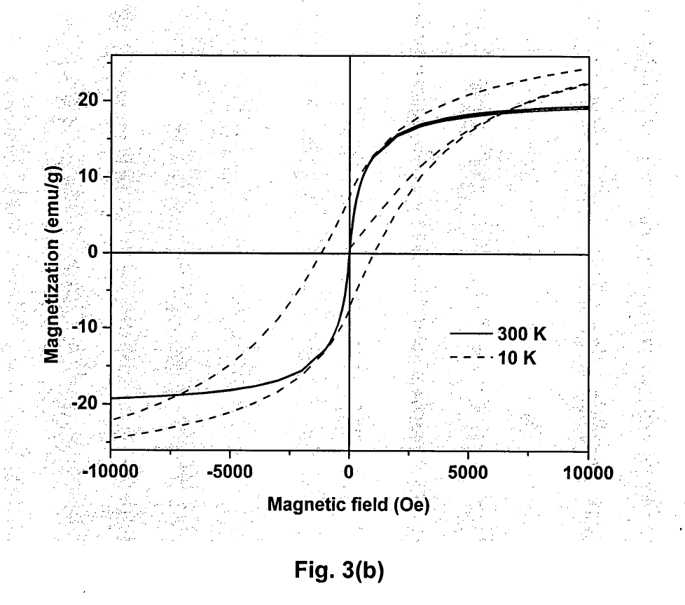

The field dependence of magnetization is depicted in FIGS. 3(a) and (b) for Co nanoparticles and Co—Cu core-shell nanoparticles, respectively. The magnetic parameters are summarized in Table 1 below. At 10 K, well below the blocking temperature, coercivity and remnant magnetization were both non-zero, as would be expected. Near room temperature (i.e., above the blocking temperature) coercivity and remnant magnetization were both zero, consistent with a superparamagnetic state. The observed coercivity at 10 K for the Co—Cu core-shell nanoparticles (−697 G) was slightly larger than that for the Co precursor (−656 G). The remnant magnetization at 10 K increased from 0.37 emu/g for the Co nanoparticles to 0.47 emu/g for the Co—Cu core-shell nanoparticles. The mass used for these determinations was total sample mass. The Co mass content in the cobalt sample was 8.4%, while that in the Co—Cu sample was 4.0%. (Most of the mass in both sample types was surfactant.) The enhanced magnetization is also reflected in the temperature dependence of the magnetization curve. When calculated per unit mass of elemental cobalt, magnetization was slightly higher for the Co—Cu nanoparticles than for the Co nanoparticles.

### EXAMPLE 6

### Electrochemical Reaction Rates

Electrochemical reaction rates were characterized with a rotating disk electrode (RDE) using linear sweep voltammetry (Solartron SI1287 and 1255B). The electrode disk area was 0.283 cm², and the rotation rate was 400 rpm. A Cu disk working electrode was used to characterize the kinetic range of the Cu reduction reaction, and a Co disk working electrode was used to characterize the anodization of Co. The counter electrode was Cu during the Cu reduction study, and Pt during the Co anodization. The applied sweep rate was 5 mV/s.

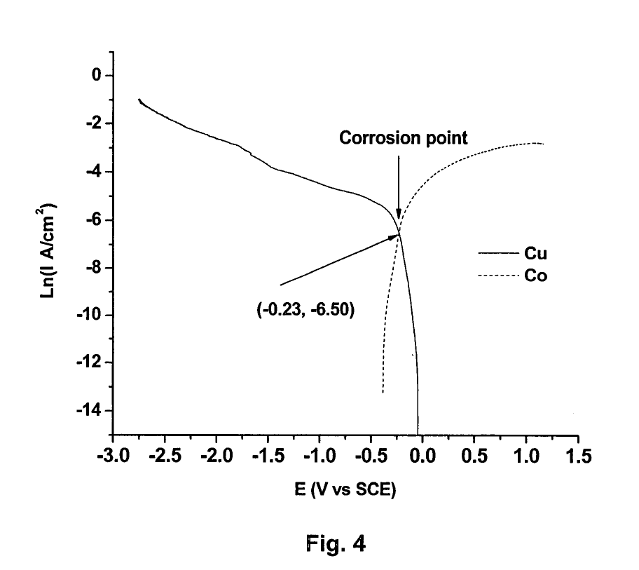

The displacement reaction rate was estimated from the Evans diagram depicted in FIG. 4, generated individually for Co/Co²⁺ and Cu/Cu²⁺ systems. The rotation rate was chosen to be fast enough to capture the kinetic regime both for bulk cobalt anodization in a copper-free electrolyte, and for copper reduction from a copper electrolyte. The mixed potential corrosion current that was observed represented an upper limit on the reaction rate. Limitations due to mass transport would tend to lower the reaction rate. The ultrasonic stirring used during the shell fabrication led us to expect a kinetic-controlled process, rather than diffusion control. The crossing point (−0.23, −6.50) of the anodic and cathodic branches of these two reactions corresponded to a displacement potential of −0.23 V vs SCE, and a current density e^{-6.5}=0.0015 A/cm². Taking the average particle diameter from the TEM micrographs as 3.2 nm, which corresponds to an average surface area of 3.22×10⁻¹³ cm², we calculated an average reaction rate of 2.51×10⁻²¹ moles/s/particle.

In the absence of Cu(II) ions a Co nanoparticle would be expected to be anodized by protons in the electrolyte, leading to the complete oxidation of solid Co nanoparticles to Co(II) ions. The fact that we observed Co nanoparticles to be preserved in the aqueous acidic environment is another confirmation of the formation of Cu shells, and of the protection they afforded to the Co cores.

### EXAMPLE 7

### Co—Cu Core-Shell Micron-Sized Particles

The technique of Example 2 was adapted to prepare cobalt-copper core-shell micron-sized particles. Cobalt microparticles purchased from Aldrich (7.162 g) were added to 100 ml cupric sulfate solution at pH 4.0. The reactants were then agitated ultrasonically for 1 hour. The reaction caused the particles to change from a gray to a copper color, indicating formation of a copper shell around the cobalt core. The copper-coated cobalt particles were allowed to settle, and the supernatant was removed. To inhibit oxidation of the copper shell, oxygen-free, de-ionized water was used to wash the precipitated particles thoroughly, until no blue color was visible in the supernatant. The particles were then filtered, dried under nitrogen flow at room temperature, and preserved as powder in a glove box.

### EXAMPLE 8

### Characterization of Nanoparticles and Micron-Sized Particles

Nanoparticles were characterized by a JEOL 2010 transmission electron microscope (TEM) with a 200 kV accelerating voltage, UV/Vis spectroscopy, and X-ray absorption spectroscopy (XAS). Samples for TEM were prepared by dripping and evaporating a THF suspension of Co particles, or an aqueous suspension of Co—Cu core-shell particles onto a carbon-coated copper grid or a gold grid, respectively, and evaporating the solvent under vacuum conditions.

Micron-sized particles were examined with a Cambridge S-260 scanning electron microscope (SEM). Magnetization measurements for all samples were made with a Quantum Design MPMS-5S superconducting quantum interference device (SQUID) magnetometer. Powder samples prepared under inert atmosphere were used for magnetization measurements. The temperature dependence of magnetization was measured in an applied magnetic field of 100 G between 5 K and 300 K using zero-field-cooled (ZFC) and field-cooling (FC) procedures. Field-dependent magnetization was measured at 10 K and 300 K. The oxidative stability of cobalt particles was studied by cooling the sample from 300 K to 10 K with an applied field of 3 Tesla and then recording the field dependence magnetization. X-ray diffraction (XRD) was conducted with a CPS120 Inel curved position-sensitive detector system using Co Kα radiation. The powder samples for XRD were loaded into a sealed aluminum container with a Kapton® film window.

X-ray absorption spectroscopy (XAS) was performed at the X-ray microprobe (XMP) double crystal monochromator beamline at port 5A of the Center for Advanced Microstructures and Devices (CAMD) synchrotron radiation source at Louisiana State University. The storage ring was operated at an electron energy of 1.3 GeV. Measurements were made in standard transmission mode, using ionization chambers filled with air at 1 atm. pressure as both intensity monitor and detector. A Lemmonier-type monochromator was equipped with Si (311) crystals. Photon energy was calibrated relative to the absorption spectra of a standard 7.5 μM Co foil and a 7.5 μM Cu foil, taking their first inflection points as 7709 eV and 8979 eV, respectively. X-ray absorption near-edge structure (XANES) spectra were collected in the −100 to +250 eV range relative to the Co and Cu K-edge, with approximate step sizes of 0.5 eV, and 1 second integration times. The data regions for the extended X-ray absorption fine structure (EXAFS) scans were (relative to the edge) [−200, −10, 40, 800] eV, and the step sizes were [3, 1, 2] eV, respectively. A 1 second integration time was used for all scanning regions. Samples for the XAS measurements were prepared by spreading a thin layer of the dried particles uniformly over Kapton® tape in air for the Co—Cu particles, and in a glove box for Co particles, at room temperature for both.

### EXAMPLE 9

### UV/Vis Absorption Spectrum of Co—Cu Core-Shell Nanoparticles

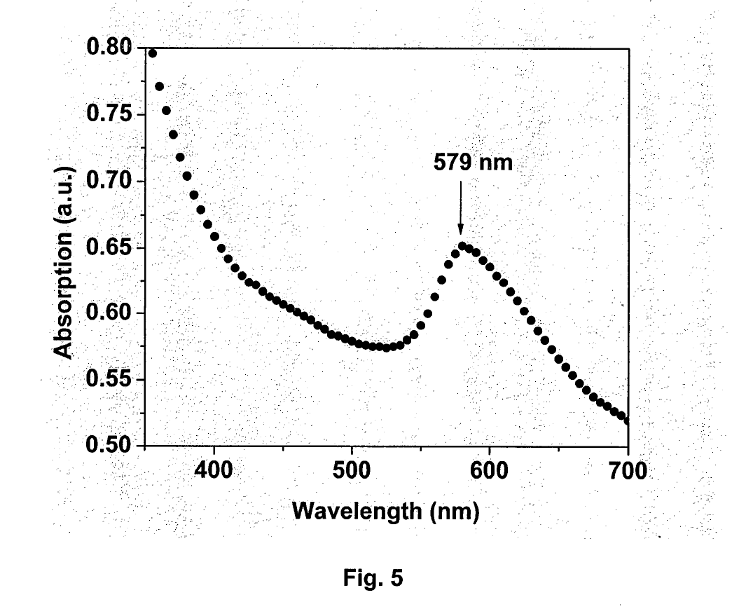

FIG. 5 depicts a typical UV/Vis absorption spectrum for synthesized Co—Cu core-shell nanoparticles well dispersed in deionized water. The plasmon resonance at 579 nm was consistent with nanosized copper, consistent with a copper shell around the cobalt core.

### EXAMPLES 10 AND 11

### Electron Microscopy of Co—Cu Core-Shell Nanoparticles and Micron-Sized Particles

Electron microscopy was carried out using SEM for micron particles and TEM for Nanoparticles. The SEM image (not shown) for the micron-sized particles revealed that the particles were spherical, with a mean diameter of 0.93 μm±0.23 μm, and that the particles were well dispersed, i.e., not agglomerated.

The Co—Cu Nanoparticles were also nearly spherical and non-agglomerated, as seen in a TEM bright field image (not shown). The nanoparticles were monodisperse, with a mean diameter of 3.2 nm±0.6 nm. We did not observe contrast differences in the TEM images. Differences in contrast, if seen, would be expected to arise from lattice fragments having different orientations with respect to the electron beam. The absence of contrast is indicative of a core-shell structure. We recognize, however, that the small difference in Z between Co and Cu may limit the use of contrast for identifying a core-shell structure in this case.

### EXAMPLES 12 AND 13

### X-Ray Diffraction of Co—Cu Core-Shell Nanoparticles and Micron-Sized Particles

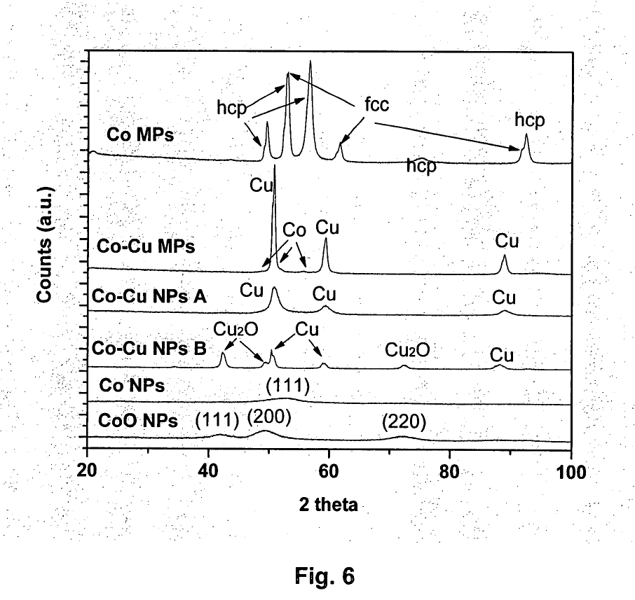

FIG. 6 depicts XRD spectra for pure nano and micron cobalt particles, for nano and micron-sized core-shell Co—Cu particles, and for oxidized CoO nanoparticles. The cobalt nanoparticles showed face-centered cubic (fcc) structure, with a typical (111 ) peak. The cobalt micron-sized particles showed primarily hexagonal close packed (hcp) structure, with a small amount of fcc structure. In FIG. 6, “Co—Cu NPs A” refers to freshly-prepared nanoparticles, while “Co—Cu NPs B” refers to nanoparticles that had been exposed to the air for several weeks, with the formation of copper oxide. The XRD spectra were taken with a Co source. More typically, Cu sources are used, but they provide poor resolution for Co. Using a Co source instead allowed us to detect even trace amounts of exposed Co.

The micron-sized Co—Cu core-shell particles showed weak hcp cobalt structure, without any cobalt oxide signal. The Co—Cu core-shell nanoparticles showed essentially no cobalt signal. The weak signal of hcp cobalt in micron core-shell particles and the disappearance of the cobalt signal in nano core-shell particles indicated that the copper shell effectively blocked X-ray diffraction from the cobalt core cobalt.

XRD patterns of both the microsize and the nanosize core-shell particles showed strong fcc copper reflections without copper oxides. The calculated average copper lattice constant in the Co—Cu nanoparticles (3.619 nm) was almost identical to that in the Co—Cu micro-sized particles (3.613 nm).

As expected, the Co—Cu nanoparticles freshly prepared or stored as powder under an inert atmosphere did not show copper oxide impurities either by XRD or XAS analysis, while the Co—Cu nanoparticles that had been immersed in water for a month under ordinary air showed Cu₂O impurities by XRD. Therefore, all measurements described in this specification were made with freshly prepared core-shell nanoparticles or microparticles, unless otherwise indicated. The aged samples used in the SQUID measurements, for example, were prepared in the same manner as the fresh samples, and then exposed to air for specified times before measurement.

### EXAMPLES 14-21

### X-Ray Absorption Spectroscopy of Co—Cu Core-Shell Nanoparticles and Micron-Sized Particles

We used X-ray absorption spectra (not shown) for element-specific analyses of the core and the shell. We compared the Co K-edge XANES spectra of the core-shell Co—Cu microparticles to that for Co microparticles, a reference hcp cobalt foil, and a theoretical hcp cobalt spectrum determined from ab initio calculations using FEFF8 code. Within the precision of the measurements, the spectra of the cobalt microparticles and of the copper-coated microparticles were identical. There were slight differences between these spectra and those for the hcp Co standard and the theoretical Co spectrum, differences that we tentatively attributed to broadening resulting from increased structural disorder and lattice faults.

We also compared XANES spectra (not shown) of Co nanoparticles, Co—Cu core-shell nanoparticles, and standard hcp Co foil. The XANES spectrum of the coated nanoparticles showed no tendency towards oxidation of Co, even after exposure to air. The Cu coating greatly increased the stability of Co nanoparticles in air. (A pre-edge “shoulder” in the spectra of Co disappears in the spectra of all cobalt oxides, but was present even slightly more strongly in the core-shell nanoparticles than in hcp cobalt foil. Also, the intensities of all shape resonances in the Co—Cu core-shell nanoparticles were low, indicating some degree of structural disorder.

We observed clear differences between micron-sized particles and nanoparticles in Cu K-edge XANES spectra (not shown). The Cu K-XANES spectrum of Co—Cu microparticles was very similar to that for standard Cu foil. However, clear changes in the region of the absorption edge were observed in Co—Cu nanoparticles: the pre-edge structure was slightly more intense, and splitting between the double structures of the “white line” was notably reduced. Here, too, the reduced intensity of the shape resonances suggested some degree of structural disorder.

### EXAMPLES 22 AND 23

### EXAFS Analysis at the Cu K-Edge for Co—Cu Core-Shell Nanoparticles and Microparticles

We conducted an EXAFS (extended x-ray absorption fine structure) analysis at the Cu K-edge using the UWXAFS evaluation package to further study the Cu shell and its interaction with the Co core. Some of the results and conclusions of this evaluation are described here qualitatively. For further details, see Z. Guo et al., “Cobalt-Core Copper-Shell Nano and Micron Particles: Electronic, Geometric, and Magnetic Properties,” manuscript (2005). Nearest-neighbor coordination numbers of 10.1 and 6.4, were determined for fcc and hcp fits, respectively. Both values were reduced from the coordination number of 12 that is seen in both fcc and hcp bulk structures. A pronounced reduction in the coordination number has previously been reported for several nanoparticle systems. This effect is partly explained by the reduced coordination of the surface-layer of atoms.

No contribution from low-Z backscatterers was observed, consistent with a metal- or mixed-metal phase.

We obtained a good fit to the data for the Co—Cu microparticles with an fcc structure—similar to bulk Cu—while an hcp model failed to reproduce the data. Interestingly, the hcp model, but not the fcc model, gave a good fit to the data for Co—Cu nanoparticles.

Summarizing the XAS results to date, it appears that in the micrometer-sized Co—Cu particles, a hcp Co core is covered by an fcc Cu shell. Whether there might also be an interfacial layer could not be resolved from our data. The Co—Cu nanoparticles were more complex; there appeared to be substantial deviations from bulk behavior in both Co and Cu. These differences may be related to size effects or interfacial mixing of the metals.

### EXAMPLES 24 AND 25

### Magnetic Properties of Co—Cu Core-Shell Nanoparticles and Microparticles

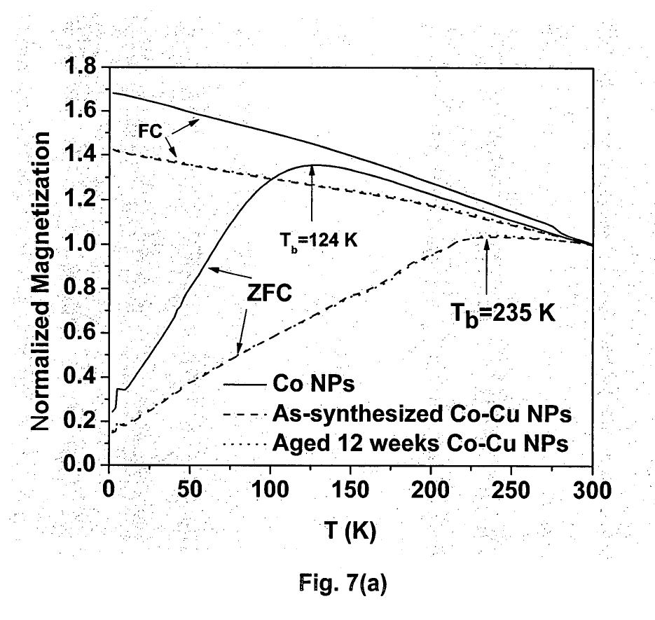

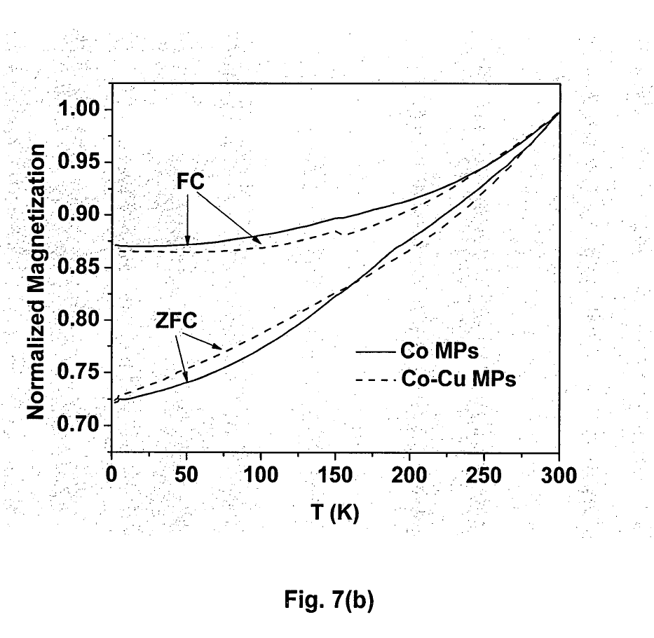

FIG. 7 depicts the temperature-dependent magnetization (normalized versus magnetization at 300 K). FIG. 7(a) depicts magnetization measurements for Co nanoparticles, freshly-prepared Co—Cu core-shell nanoparticles, and Co—Cu core-shell nanoparticles aged 12 weeks in air at room temperature. FIG. 7(b) depicts magnetization measurements for Co microparticles, and freshly-prepared Co—Cu core-shell microparticles. Both figures depict ZFC and FC magnetization. The blocking temperature, T_{B}, determined as the maximum of the ZFC curve, indicates the transition from ferromagnetism to the superparamagnetic regime. As shown in FIG. 7(a), Co nanoparticles had a T_{B} of 124 K. The core-shell Co—Cu nanoparticles had a blocking temperature over 100 degrees higher, 235 K.

By contrast, as depicted in FIG. 7(b), the blocking temperatures both of the Co microparticles and of the Co—Cu core-shell microparticles were substantially above room temperature, presumably due to a size approaching bulk dimensions. The blocking temperature in these cases was inferred from the measured coercivity at two temperatures, T₁ and T₂, from the relationship H_{C}(T₁)/[1−(T₁/T_{B})^{2/3}]=H_{C}(T₂)/[1−(T₂/T_{B})^{2/3}]. On this basis, a much higher T_{B} (1212 K) was inferred for the Co—Cu core-shell microparticles than for the cobalt microparticles (848 K). The larger slope of the normalized FC magnetization curve indicated a weaker inter-particle interaction. At both the microscale and the nanoscale, the Co—Cu core-shell particles showed slightly stronger inter-particle interactions as compared to the unmodified Co particles; this effect may be responsible for the increase of the blocking temperature.

The zero-field cooled hysteresis loop was either normalized at the measured saturation magnetization, or by using the extrapolated saturation magnetization obtained from the intercept of magnetization vs H⁽⁻1/2) for samples that had not reached saturation at an applied field of 5 Tesla. The existence of hysteresis at 300 K for both the Co microparticles and for the Co—Cu core-shell microparticles is consistent with the high blocking temperature (data not shown). Similarly, for nanoparticles, the observed hysteresis loop was consistent with the observed T_{B} for the Co and Co—Cu nanoparticles, as evidenced by the superparamagnetic behavior at 300 K.

Measured coercivity values included, for the Co—Cu microparticles, Hc=285 G at 10 K and 180 G at 300 K, and for the Co microparticles, Hc=330 G at 300 K. The coercivity for the Co—Cu microparticles decreased with temperature, and at 10 K was nearly the same as the coercivity of Co microparticles at 300 K. An increase in coercivity with decrease in temperature was observed for both Co—Cu microparticles and Co—Cu nanoparticles. The ratio of remnant magnetization to saturation magnetization for the Co—Cu nanoparticles was lower than that for the cobalt nanoparticles. Note that the temperature dependence of coercivity for the nanoparticles was the reverse of that for microparticles. (Hc: 698 G for Co—Cu nanoparticles and 656 G for Co nanoparticles). The coercivity changes after Cu shell formation were consistent with a single-domain cobalt core nanoparticle, and a multi-domain cobalt core microparticle. An increase of coercivity with decreased particle size was also observed.

### EXAMPLES 26 AND 27

### Analyses for Cobalt Oxide Impurities

The potential presence of cobalt oxide impurities in the core-shell structure was monitored by looking for shifts in the field-cooled hysteresis loop. If the cobalt core were oxidized or partially oxidized, then the hysteresis loop would be expected to shift towards an applied magnetic field, due to exchange coupling between the ferromagnetic core and the antiferromagnetic shell. In fact, we observed nearly overlapping FC and ZFC hysteresis curves (data not shown) for Co—Cu microparticles that had been exposed to air, indicating that negligible amounts of cobalt oxide had formed. Likewise, a negligible amount of cobalt oxide formed in Co—Cu nanoparticles that had been exposed to air for four months. Also, there was no change in T_{B} for the Co—Cu nanoparticles after aging for 4 months in air, consistent with the conclusion that no significant amount of cobalt oxide had formed.

### EXAMPLES 28 AND 29

### Magnetic Moments

The magnetic moment of the particles was calculated from the equation m=2.83 (X^{T})^{0.5} where m is the magnetic moment=μ_{B};X is the molar susceptibility, emu/mole; and T is the temperature, K. The magnetization (emu/g) was determined from the known cobalt content (as analyzed by atomic absorption spectroscopy), and a density assumed to be the same as that for bulk cobalt (8900 kg/m³). Table 1 summarizes magnetic properties for the various particle types. Note that formation of the Cu shell around the Co enhanced the magnetic moment considerably.

TABLE 1

| | | | Co mass fraction, % of total | | Magnetic |
|---|---|---|---|---|---|
| | | M | (including mass of surfactant, | Susceptibility | moment |
| | T (K) | (emu/g) | and mass of any Cu present) | (emu/mole) | (μ_{B}) |
| Co nanoparticles | 300 | 0.11 | 8.36 | 2.23 × 10⁻⁴ | 0.733 |
| | 10 | 0.04 | 8.36 | 8.12 × 10⁻⁵ | 0.081 |
| Co microparticles | 300 | 3.75 | 45.9 | 1.39 × 10⁻³ | 1.826 |
| | 10 | 2.72 | 45.9 | 1.01 × 10⁻³ | 0.284 |
| Co—Cu | 300 | 0.26 | 4 | 1.10 × 10⁻³ | 1.628 |
| nanoparticles | 10 | 0.05 | 4 | 2.12 × 10⁻⁴ | 0.130 |
| Co—Cu | 300 | 3.19 | 18.6 | 2.91 × 10⁻³ | 2.645 |
| microparticles | 10 | 2.33 | 18.6 | 2.13 × 10⁻³ | 0.413 |

### EXAMPLES 30 AND 31

### Comparison of Magnetic Properties of Co—Cu Core-Shell Nanoparticles and Co—Au Core-Shell Nanoparticles

We also prepared Co—Au core-shell nanoparticles, and compared their properties to those of Co—Cu core-shell nanoparticles. Temperature and field-dependent magnetization results both showed that a copper shell provided more effective protection against oxidation than did a gold shell. On the other hand, the Co—Cu nanoparticles had a lower blocking temperature and a lower magnetic moment than those of the Co—Au nanoparticles. Metallic conduction was observed in compacted samples of both types of core-shell nanoparticles, despite the presence of the stabilizing organic surfactant.

Gold shells were formed on cobalt nanoparticles by displacement reaction with KAuCl₄ (0.024 M) in THF solution under ultrasonication in a glove box. The initially brown solution changed to blue, indicating that the gold ions had oxidized surface cobalt atoms on the nanoparticles. The reaction was continued for an additional hour. The core-shell nanoparticles were washed thoroughly with THF, and dried under vacuum.

The Co—Cu nanoparticles used for comparison were prepared as previously described. Except as otherwise stated, the procedures used for measuring the properties of these nanoparticles were as previously described above. Samples used in transport property measurements were prepared by cold pressing, and measurements were made using a standard four-probe technique.

TEM bright field images of the Co—Cu and Co—Au core-shell nanoparticles showed that the core-shell nanoparticles were spherical and monodisperse, with diameters of 3.2 nm±0.6 nm and 2.7 nm±0.5 nm, respectively. The shell thicknesses of copper and gold were calculated as 0.82 nm and 0.67 nm, respectively, based on average concentrations determined from atomic adsorption analysis, and assuming a uniformly symmetric spherical shape. XRD data showed only gold or copper reflections, indicating either that the metal shell hindered diffraction from the cobalt core, or that the cobalt core was amorphous. However, TEM and XAS analyses showed that the cobalt was not amorphous, implying that the metal shells did completely cover the cobalt cores.

The blocking temperature for freshly prepared Co—Au core-shell nanoparticles lay outside the range of our experiments, and was therefore estimated (from the relationship described above) as 1171 K. After the Co—Au nanoparticles had been exposed to air for 4 months, the estimated blocking temperature rose to 1277 K. By contrast, as previously described the blocking temperature for the Co—Cu nanoparticles was 235 K at an applied field of 100 G, a value that remained essentially unchanged after 3-month and 7-month exposures to air. We attributed these differences to stronger interparticle interactions for Co—Au nanoparticles than for Co—Cu nanoparticles. We attributed the increased blocking temperature in the 4-month aged Co—Au nanoparticles to newly-formed cobalt oxide. The stability of the blocking temperature in the Co—Cu nanoparticles after exposure to air indicated that the copper shell was effective in protecting the cobalt core from oxidation.

The Co—Au nanoparticles were ferromagnetic even at room temperature, as shown by their non-zero coercivity and remnant magnetization. The Co—Cu nanoparticles had zero coercivity and zero remnant magnetization at 300 K, and non-zero coercivity and non-zero remnant magnetization at 10 K, indicating that the nanoparticles were superparamagnetic at 300 K and ferromagnetic at 10 K. There was an asymmetry in the hysteresis loop for the Co—Au core-shell nanoparticles (data not shown), showing that magnetization was dependent on the applied magnetic field. The asymmetric. hysteresis loop also showed that saturation occurred in two steps. We attribute the more-rapidly saturated portion of the loop to the ferromagnetic cobalt cores, and the more-slowly saturated part to the cobalt oxide. The symmetric hysteresis loops of the Co—Cu core-shell nanoparticles (data not shown) indicated that the field-dependent magnetization in that system was independent of the applied magnetic field, and that there was no significant oxidation of the cobalt core.

The change of FC magnetization in response to an applied magnetic field may be used to monitor oxidation in the cobalt core. The hysteresis loop should shift toward the applied field if there is an antiferromagnetic cobalt oxide layer around the ferromagnetic cobalt core, due to exchange coupling between the antiferromagnetic and ferromagnetic media. The field-cooled hysteresis loop was measured by cooling the sample from 300 K to 10 K in an applied magnetic field of 3 Tesla, then resetting the field to zero before taking measurements. We observed such shifts in the hysteresis loop both for Co—Au nanoparticles that had been exposed to air for 4 months, and for Co—Cu nanoparticles exposed to air for 7 months (ZFC coercivity shift of 26% for Co—Au and 18% for Co—Cu nanoparticles at 10 K), indicating in both cases that at least part of the surface cobalt had been oxidized. However, the observed stability in the blocking temperature of the Co—Cu nanoparticles suggested that there were only negligible amounts of cobalt oxide in the Co—Cu nanoparticles. In marked contrast, there was a large change in the blocking temperature for the Co—Au core-shell nanoparticles after exposure to air, indicating the formation of substantial amounts of cobalt oxide.

These data (those pertaining to the blocking temperature, ZFC hysteresis curves, and shifts in FC hysteresis loops following aging in air) led us to conclude that copper shells were substantially more effective than gold shells in protecting a cobalt nanoparticle core from oxidation.

### EXAMPLES 32 AND 33

### Comparison of Electrical Conductivity of Co—Cu Core-Shell Nanoparticles and Co—Au Core-Shell Nanoparticles

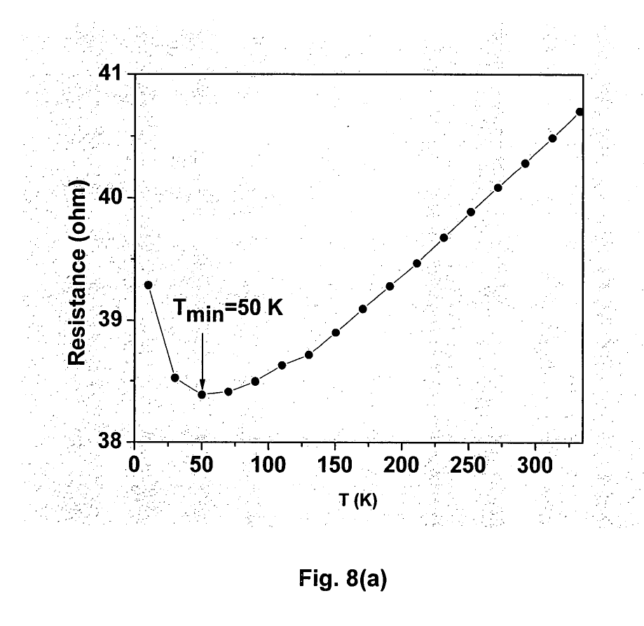

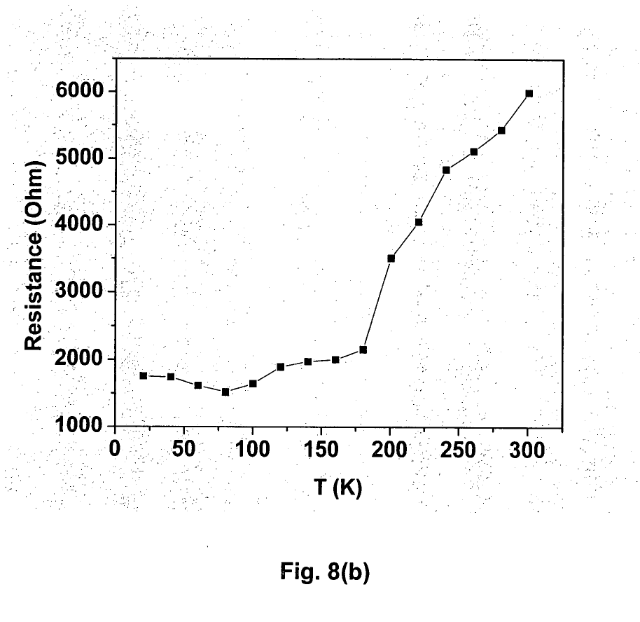

FIGS. 8(a) and (b) depict the electrical resistance of Co—Au and Co—Cu nanoparticles, respectively, as functions of temperature. The samples were prepared by cold-pressing the nanoparticles into pellets at zero magnetic field. The resistance of the Co—Au nanoparticles reached a minimum at Tₘᵢₙ=50 K. Above Tₘᵢₙ, the electrical resistance behaved as that of a metal, as shown by the positive, nearly linear slope of the resistance with increasing temperature.

The plot of electrical resistance as a function of temperature was more complex for the Co—Cu nanoparticles. Nevertheless, an increase in resistance with increasing temperature, despite the presence of surfactant surrounding the core-shell nanoparticles, indicated that the particles were metallic conductors.

### EXAMPLE 34

### Preparation of Cobalt Core, Copper Shell Nanowires

The invention is not limited to core-shell nanospheres and microspheres. It may also be used to provide shells around other ferromagnetic nano- and micro-materials, such as nanorods, nanotubes, or nanowires. Magnetic nanorods may be used in biomolecular separations. Magnetic nanowires are used in biomedical applications, such as applying force to individual cells, as well as in giant magneto resistive (GMR) sensors. See, e.g., K. Lee et al., “Multicomponent Magnetic Nanorods for Biomolecular Separations,” Angew. Chem. Int. Ed., vol. 43, pp. 3048-3050 (2004); D. Reich et al., “Biological applications of multifunctional magnetic nanowires,” J. Appl. Phys., vol 93, pp. 7275-7280 (2003); D. Tulchinsky et al., “Fabrication and Domain Imaging of Iron Magnetic Nanowire Arrays,” J. Vac. Sci. Tech. A, vol. 16, pp. 1817-1819 (1998); and A. Hultgren et al., “Cell manipulation using magnetic nanowires,” J. Appl. Phys., vol 93, pp. 7554-7556 (2003).

For example, the invention may be used to prepare nanowires having a cobalt core and a copper shell. A cobalt nanowire core may be prepared through techniques known in the art, for example that of S. G. Yang et al., “A study of cobalt nanowire arrays,” J. Phys. D: Appl. Phys., vol. 33, pp. 2388-2390 (2000). The cobalt nanowires are added to a copper-citrate electrolyte, containing 0.25 M CuSO₄.5H₂O, and 0.3 M sodium citrate C₆H₅Na₃O₇.2H₂O, at a pH of 4.0. The reactants are agitated ultrasonically for 1 hour under air. After reaction, the color of the cobalt nanowires changes from gray to copper color, indicating the formation of copper shells around the cobalt core nanowires. The nanowires are removed from the electrolyte by precipitation, and are washed thoroughly with deionized water, filtered, and dried under nitrogen flow. To inhibit oxidation of the copper shell, the precipitated cobalt core-copper shell nanowires are thoroughly washed with oxygen-free deionized water blue color is observed in the supernatant.

### EXAMPLE 35

### Preparation of Cobalt Core, Copper Shell Nanodisks

Cobalt core, copper shell nanodisks are prepared following the method of Example 34, except that the starting materials are cobalt nanodisks instead of nanowires. The cobalt nanodisk cores may be prepared, for example, by the method of V. Puntes et al., “Synthesis of hcp-Co Nanodisks,” J. Am. Chem. Soc., vol. 124, pp. 12874-12880 (2002).

### EXAMPLE 36

### Preparation of Iron Core, Copper Shell Nanowires

Iron core, copper shell nanowires are prepared following the method of Example 34, except that the starting materials are iron nanowires instead of cobalt nanowires. The iron nanowire cores may be prepared, for example, by the method of S. Park et al., “Synthesis and magnetic studies of uniform iron nanorods and nanospheres,” J. Am. Chem. Soc., vol. 122, pp. 8581-8582 (2000).

### EXAMPLE 37

### Preparation of Iron Core, Copper Shell Nanospheres

Iron core, copper shell nanowires are prepared following the method of Example 34, except that the starting materials are iron nanospheres instead of cobalt nanowires. The iron nanosphere cores may be prepared, for example, by the method of S. Park et al., “Synthesis and magnetic studies of uniform iron nanorods and nanospheres,” J. Am. Chem. Soc., vol. 122, pp. 8581-8582 (2000).

Miscellaneous

As used in the specification and claims, unless context clearly indicates otherwise, an “aqueous solution” should be understood to refer to a solution in which at least 50% of the solvent (by volume) is water. Other solvents may be admixed with the water, particularly polar solvents such as THF, methanol, ethanol, DMF, and DMSO; the resulting solution is still considered to be an “aqueous solution” provided that at least 50% of the solvent (by volume) is water.

The complete disclosures of all references cited in this specification are hereby incorporated by reference. Also incorporated by reference are the complete disclosures of the following papers, none of which is believed to be prior art to the present application: Z. Guo et al., “Displacement synthesis of Cu shells surrounding Co nanoparticles,” J. Electrochem. Soc., vol. 152, pp. D1-D5 (2005); Z. Guo et al., “Cobalt-core copper-shell nano and micron particles: Electronic, geometric and magnetic properties,” (manuscript 2005); Z. Guo et al., “Magnetic behavior of Co—Cu and Co—Au core-shell nanoparticles,” (manuscript 2005). In the event of an otherwise irreconcilable conflict, however, the present specification shall control.

We claim:

1. A process for forming a metal shell on a metal article; wherein the article comprises a zero-valent first metal selected from the group consisting of nickel, cobalt, and iron; wherein the article is substantially free of oxides of the first metal; and wherein at least one dimension of the article is between about 1 nm and about 100 μm; said process comprising the steps of:
(a) placing the article in an aqueous solution, wherein:
(i) the solution comprises cations of a second metal selected from the group consisting of copper, gold, silver, platinum, palladium, nickel, and cobalt;
provided that if the second metal is nickel, then the first metal is cobalt or iron; and provided that if the second metal is cobalt, then the first metal is iron;
(ii) the solution comprises a surfactant that will inhibit agglomeration of the article to any similar articles in the aqueous solution.
(iii) the solution comprises a retarding agent that will bind to or coordinate with the second metal cations in solution, or that will bind to or coordinate with the zero-valent metal atoms on the surface of the article, or both;
(iv) the pH of the solution supports oxidation of the first metal, but the pH of the solution does not support formation of an oxide of the first metal, and the pH does not support the evolution of hydrogen gas at a rate sufficient to consume a substantial portion of the article;
(b) allowing the article to react with the second metal cations in the aqueous solution; wherein redox reactions at the surface of the article result in oxidation and solvation of atoms of the first metal, and reduction and deposition of atoms of the second metal; wherein a layer of zero-valent second metal is formed on the surface of the article; wherein, after the zero-valent second metal layer has been deposited on the surface of the article, the zero-valent second metal layer inhibits further redox reactions at the surface of the article; and wherein, as compared to an otherwise identical process that lacks the retarding agent, the deposition of the second metal onto the surface of the article is substantially slower, and the layer of the second metal that forms on the surface of the article is substantially more uniform.

2. A process as recited in claim 1, wherein the retarding agent is selected from the group consisting of citrate, borate, and ethylenediaminetetraacetic acid.

3. A process as recited in claim 1, wherein the retarding agent comprises citrate.

4. A process as recited in claim 1, wherein the retarding agent comprises a bidentate ligand.

5. A process as recited in claim 1, wherein said process is conducted simultaneously on a plurality of articles.

6. A process as recited in claim 1, wherein the shape of the article is a sphere, a wire, a cube, a disk, a tube, or a rod.

7. A process as recited in claim 1, wherein at least one dimension of the article is between about 1 nm and about 100 nm.

8. An article produced by the process of claim 1.

9. A plurality of articles as recited in claim 8.

10. An article as recited in claim 8, wherein the shape of said article is a sphere, a wire, a cube, a disk, a tube, or a rod.

11. An article as recited in claim 8, wherein at least one dimension of the article is between about 1 nm and about 100 nm.

12. An article comprising an inner core and an outer shell; wherein at least one dimension of the article is between about 1 nm and about 100 μm; wherein said core comprises a ferromagnetic metal selected from the group consisting of cobalt, iron, and nickel; wherein said sore is substantially free of oxides of the ferromagnetic metal; and wherein said shell comprises a copper layer adhering to said core.

13. A plurality of articles as recited in claim 12.

14. An article as recited in claim 12, wherein the shape of said article is a sphere, a wire, a cube, a disk, a tube, or a rod.

15. An article as recited in claim 12, wherein at least one dimension of the article is between about 1 nm and about 100 nm.

16. An article as recited in claim 12, wherein said ferromagnetic metal is nickel.

17. An article as recited in claim 12, wherein said ferromagnetic metal is iron.

18. An article as recited in claim 12, wherein said ferromagnetic metal is cobalt.
